(19) United States
(12) Patent Application Publication
(10) Pub. No.: US 2005/0152245 A1
(43) Pub. Date: Jul. 14, 2005

(54) METHOD FOR CONTROLLING A SLED-HOME OPERATION

(76) Inventors: Tung-Wei KAO, Taipei City (TW); Hsiang-Yi Fu, Taipei City (TW); Chi-Feng Chen, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/905,338

(22) Filed: Dec. 28, 2004

(30) Foreign Application Priority Data
Jan. 8, 2004 (TW) 093100456

(51) Int. Cl. G11B 5/09

(52) U.S. Cl. 369/47.36; 369/44.28

(57) ABSTRACT

A method for controlling a sled-home operation in an optical disc drive by driving a sled motor. The method includes two stages: a motor-starting stage and a sled-home-driving stage. In the motor-starting stage, the sled motor is driven at a first target speed. In the sled-home-driving stage, the target of the sled motor is gradually changed to a second target speed greater than the first target speed. The second target speed is less than or equal to the speed Rm that corresponds to a maximum allowable excitation frequency for the sled motor to overcome a dynamic friction torque and greater than the speed Rs that corresponds to a maximum allowable excitation frequency for the sled motor to overcome a static friction torque.

### BACKGROUND OF INVENTION

1. Field of the Invention

The present invention relates to a method for controlling an optical disc drive, and more particularly, to a method for controlling a sled-home operation in an optical disc drive.

2. Description of the Prior Art

With the progress of electrical technology and the popularity of multimedia applications, the demand for storage devices with high memory capacity and low cost increases gradually. Data stored in optical storage media can be stored for a long time and such media is convenient and portable. Take an optical disc drive system for example. A user can replace an optical disc in the optical disc drive easily and thereby the optical disc drive becomes the main storage media for copying and exchanging data. When the user replaces the optical disc in the optical disc drive, the optical disc drive performs a disc-loading operation and some initializations, such that the user can operate the optical disc drive. The disc-loading operation includes a basic step: a sled-home operation.

Please refer to FIG. 1, which illustrates the corresponding locations of a sled 134 and other elements in an optical disc drive 100. The optical disc drive comprises a spindle motor 110, a pick-up head 132, a sled 134, a sled motor 142, a gear set 144, and a rack 146. Moreover, a dotted square region illustrates an optical disc location 120 in the optical disc drive 100. The optical disc location 120 represents the location of an optical disc inside the optical disc drive while a disc is being accessed. The location 120 is above the spindle motor 110 such that the disc is fixed onto the spindle motor 110 during operation. The rack 146 is connected to a side of the sled 134. The pick-up head 132 is located on the sled 134. The sled 134 is located on a guiding device (not shown in FIG. 1, please refer to 232A and 232B in FIG. 2) so that the sled 134 can move along the guiding device (232A and 232B). In addition, the sled motor 142 drives the gear set 144, and the gear set 144 engages the rack 146. Therefore, the sled motor 142 directly controls the speed and movement of the sled 136 and also controls the pick-up head 132. As it is well known in the art, the relationship of the sled 132 and the sled motor 142 is omitted herein. The gear set 144 is driven by the sled motor 142 to make the sled 132 move, and can be replaced by other devices capable of achieving the same function of the gear set 144, such as a guide screw.

Please refer to FIG. 2, which illustrates the corresponding locations of the sled 134 and other elements. The optical disc drive 100 further comprises a guiding device having two parallel guiding bars 232A and 232B. In FIG. 2, an inner location 242 and an outer location 244 represent the allowable movement range for the sled 134 sliding along the two guiding bars 232A and 232B, such that the pick-up head 132 can access the entire optical disc. Generally, there are mechanisms (not shown in FIG. 2) set in the inner location 242 and the outer location 244 so as to precisely limit the allowable movement range of the sled 132 or the rack 146.

Please refer to FIG. 1 and FIG. 2 again. When the disc-loading operation is performed, the sled-home operation is performed to drive the sled 134 to move to the inner location 242 so that the pick-up head 132 can access data from the inner region of the optical disc. However, when the disc-loading operation is performed, the optical disc drive 100 might not have the information of current location of the sled 134. Even if the optical disc drive 100 does, the sled 134 might be moved due to an external force or an improper operation. One feasible solution to this problem is to use a complex calculation and detection of the current location of the pick-up head 132 so that a movement of the sled-home operation is calculated to directly relocate the sled 134 to the inner location 242. Nevertheless, the complex calculation and extra necessary detecting devices will increase the complexity and cost of the entire system. Another solution is to drive the sled 134 to move a maximum range toward the inner location 242, wherein the maximum range is approximately the same as the distance from the outer location 244 to the inner location 242. In this way, no matter the initial location of the sled 134, the sled 134 can arrive at the inner location 242 to accomplish the sled-home operation. Even if the initial location of the sled 134 is at the outer location 244, the sled 134 can arrive at the inner location 242 by this method.

In addition to drive the sled 134 to move the maximum range toward the inner location 242, a sensor, such as a light-coupled switch or a mechanical switch (not shown in FIG. 2), should be set at the inner location 242 for detecting whether the sled 134 arrives at the inner location 242. If the sensor detects that the sled 134 arrives at the inner location 242, the optical disc drive 100 will stop driving the sled motor 142 to stop the sled 134 from moving. If there is no sensor in the inner location 242, when the sled 134 reaches the inner location 242, the sled motor 142 is still driven which is an improper operation and might damage elements in the optical disc drive 100. For example, if the sled motor 142 were a stepping motor, the sled 134 would noisily vibrate at the inner location 242 because the sled motor 142 is still being driven. However, the sensor set at the inner location 242 also increases the cost and the complexity of the assembly.

As mentioned above, in order to perform the sled-home operation, no matter which prior art method is used, a complex calculation for calculating the initial location of the sled, or extra hardware elements for detecting the current location of the sled, the prior art would increase the cost and the complexity of the optical disc drive, and might increase the possibility of malfunction of the optical disc drive.

### SUMMARY OF INVENTION

It is therefore a primary objective of the claimed invention to provide a method for controlling a sled-home operation to solve the above-mentioned problem.

The claimed invention takes advantage of the properties of a stepping motor, such as positioning precision and easy control. The claimed invention takes a stepping motor as the sled-motor so that the control of the pick-up head of the optical disc drive is optimized. In order to decrease the complexity of the system, the claimed invention does not have to obtain the initial position of the sled, nor does it have to have a sensor at the inner location of the sled.

The claimed invention provides a method for controlling a sled-home operation. The claimed invention can accomplish the sled-home operation without obtaining the initial position of the sled and without a sensor set at the inner location of the sled. Furthermore, when the sled arrives at the inner location, the sled is properly stopped so that the sled does not vibrate or shake at the inner location and thereby no noise is made.

The method includes steps: driving the sled motor at a first target speed, and driving the sled motor according to a target speed curve. The target speeds of the target speed curve should be all less than or equal to a speed Rm that corresponds to a maximum allowable excitation frequency for the sled motor to overcome a dynamic friction torque, and it should be greater than a speed Rs that corresponds to a maximum allowable excitation frequency for the sled motor to overcome a static friction torque.

In the step for driving the sled motor according to a target speed curve, it further includes a step to change the target speed of the sled motor from the first target speed to a second target speed greater than the first target speed and the speed Rs, and the second target speed is less than or equal to the speed Rm.

The claimed invention further provides a device for controlling a sled-home operation, including a sled, a sled motor and a control circuit for executing the control method mentioned above. The circuit can be a microprocessor for executing a firmware program code. Moreover, the circuit can also be a logic circuit to execute the control method.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a side view illustrating the corresponding locations of a sled and other elements in an optical disc drive.

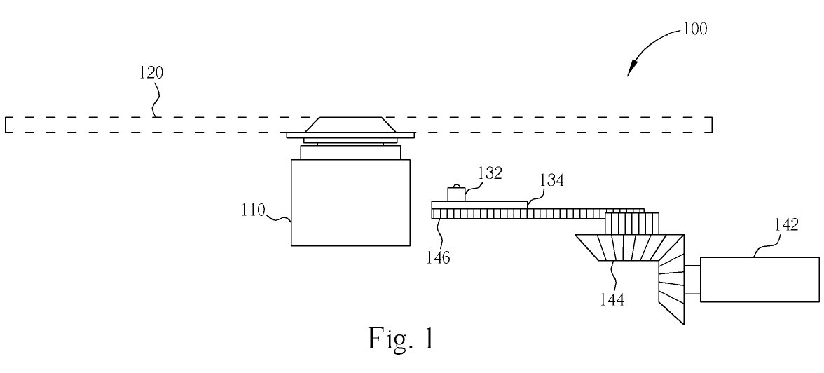

FIG. 2 is a top view illustrating the corresponding locations of the sled and other elements.

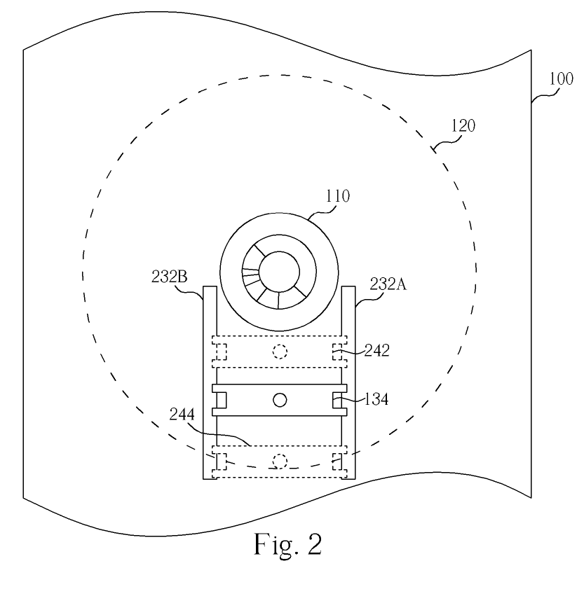

FIG. 3 is a diagram of a stepping motor illustrating the control method of the stepping motor.

FIG. 4 is a clock state diagram illustrating control signals of the stepping motor.

FIG. 5 is a flowchart of the sled-home operation based on the present invention.

FIG. 6 is a graph of target speeds of the stepping motor.

### DETAILED DESCRIPTION

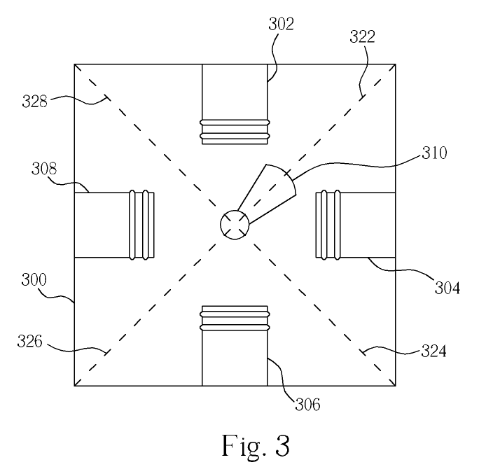

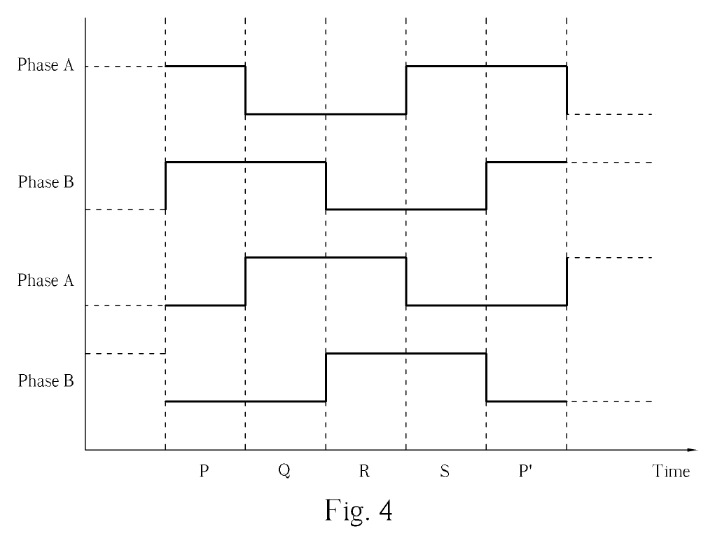

Please refer to FIG. 3, which is a diagram of a stepping motor 300 illustrating the control method of the stepping motor 300. The stepping motor 300 is taken as the above-mentioned sled motor, including a rotor 310, a phase A stator 302, a phase B stator 304, a phase A′ stator 306, and a phase B′ stator 308. The rotor 310 has a specific magnetic field and thereby the protrusion of the rotor 310 is directed to a direction of an external magnetic field. Magnetic direction of each stator is changed by an external control signal and all magnetic directions generated by the stators are combined to an equivalent magnetic direction for controlling the rotor 310. Please refer to FIG. 4, which is a clock state diagram illustrating control signals of the stepping motor 300 so as to control the excitation frequency of the stepping motor 300. Each phase control signal is changed between a high voltage and a low voltage for changing the magnetic direction of the corresponding stator. The four phase control signals control the rotating direction and the speed of the rotor 310. Note that the stepping motor 300 in FIG. 3 and FIG. 4 is a simplified two-phase stepping motor. As is known to one of the ordinary skill in the art, this concept can be used in other types of stepping motors.

In addition, there are four dotted lines in FIG. 3, representing four different directions of the rotor 310. Please refer to the control signals of FIG. 4. The P-Q-R-S duration is a cycle of a control signal. The P′ duration represents the next cycle, corresponding to the P duration. An A-B direction 322 represents the direction of the rotor 310 when the phase A stator 302 and the phase B stator 304 are excited by the high voltage during the P (or P′) duration; a B-A′ direction 324 represents the direction of the rotor 310 when the phase B stator 304 and the phase A′ stator 306 are excited by the high voltage during the Q duration; an A′-B′ direction 326 represents the direction of the rotor 310 when the phase A′ stator 306 and the phase B′ stator 308 are excited by the high voltage during the R duration; and a B′-A direction 328 represents the direction of the rotor 310 when the phase B′ stator 308 and the phase A stator 302 are excited by the high voltage during the S duration. When the control signal is changed according to the sequence P-Q-R-S, the rotor 310 rotates clockwise. The interval of each P, Q, R, and S corresponds to an excitation frequency and each excitation frequency corresponds to a target speed of the stepping motor 300. In an optimal condition, the rotor 310 of the stepping motor 300 rotates at the corresponding target speed. However, due to friction and drag inherent in the mechanism, the rotor 310 has to overcome a static friction torque. If the magnetic field intensity is too weak or if the excitation frequency is higher than a critical frequency, the rotor 310 does not respond to the change of magnetic directions; that is, the rotor 310 does not rotate. This phenomenon is known as “out-of-step” and should be avoided when driving the stepping motor. Note that the critical frequency corresponds to a target speed Rs and is the maximum allowable excitation frequency for the stepping motor 300 to overcome the static friction torque.

The stepping motor 300 is used as the sled motor 142. First, the above-mentioned maximum range should be converted into a total step number of the stepping motor 300 according to the ratio of the rack 146 and the gear set 144. When performing the sled-home operation, the stepping motor 300 rotates based on the total step number. Supposing that the sled-home operation is performed on the sled 134, if the distance between the initial location of the sled 134 and the inner location 242 is shorter than the maximum range, the sled 134 just arrives at the inner location 242 and cannot move further due to the mechanism. Please refer to FIG. 3 and FIG. 4 again. For instance, at the same time, if the direction of the rotor 310 is the A-B direction 322, the corresponding phase control signals should be those in the P duration. Note that there is no sensor at the inner location 242. Therefore, when entering the Q duration, the rotor 310 should theoretically rotate clockwise to the B-A′ direction 324. However, the sled is limited at the inner location 242 due to the mechanism. The magnetic field cannot make the rotor 310 rotate to the B-A′ direction 324 and the rotor 310 is kept at the A-B direction 322. Similarly, when entering the R duration, the rotor 310 is still kept at the A-B direction 322. However, when entering the S duration, the equivalent magnetic direction is B′-A′ direction 328. If the target speed of the stepping motor 300 is less than or equal to the speed Rs, the rotor 310 rotates to the B′-A direction 328. In this condition, the sled 134 will move a little outward. When entering the P′ duration, the rotor 310 will rotate to the A-B direction 322 again so that the sled 134 arrives at the inner location 242. As mentioned above, the sled 134 moves toward the inner location 242, moves outward and then moves to the inner region over and over again. This causes a vibration that might damage other elements of the mechanism and also might make noise. The vibration does not stop until the control signal corresponding to the total step number is ceased.

The present invention further solves the problem of the vibration without an extra sensor at the inner location 242. Therefore, the present invention further provides a method for driving the stepping motor 300. The method includes two stages to drive the stepping motor 300. One is a motor-starting stage and the other is a sled-home-driving stage. In the motor-starting stage, the stepping motor 300 is driven at a first target speed less than or equal to the speed Rs. The purpose of the motor-starting stage is to overcome static friction torque. When the stepping motor 300 is capable of rotating according to control signals, the sled-home-driving stage is entered. In this stage, a target speed curve is provided so that the sled 134 is driven to arrive at the inner location 242. The target speed curve includes acceleration or deceleration to achieve the optimization of the sled movement. The target speeds of the target speed curve should be all greater than the speed Rs and should be less than or equal to a speed Rm that corresponds to the maximum allowable excitation frequency for the stepping motor 300 to overcome the dynamic friction torque. When the sled 134 arrives at the inner location 242, the rotor 310 will be directed at a specific direction, such as the A-B direction 322. When the equivalent magnetic field of the stepping motor 300 continues changing, the rotor 310 cannot overcome the static friction torque anymore or reverses extremely little since the stepping motor 300 is driven by a target speed greater than the speed Rs. Therefore, the out-of-step phenomenon occurs that prevents the sled 134 from moving outward. The present invention uses the out-of-step phenomenon to solve the vibration issue.

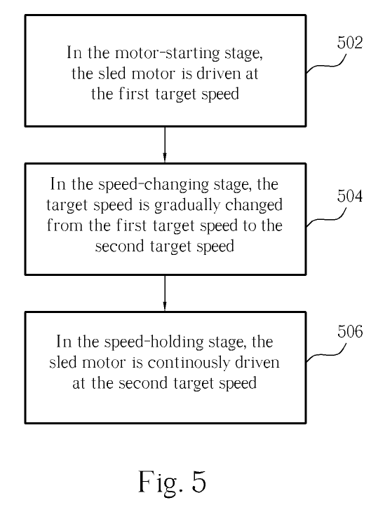

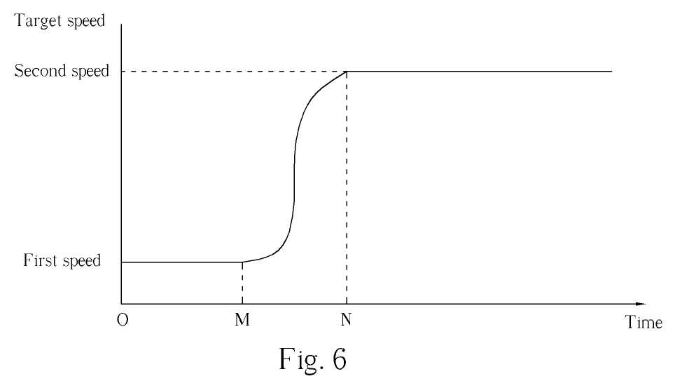

Please refer to FIG. 5, which is a flowchart of the sled-home operation based on the present invention. Please also refer to FIG. 6, which is a graph of target speeds of the stepping motor 300. In step 502, the sled motor 142 is driven at the first target speed in the motor-starting stage. The first target speed is shown as the period from O to M. Next, the sled-home-driving stage includes a speed-changing stage, and a speed-holding stage. In the speed-changing stage (step 504), the target speed of the stepping motor 300 is gradually changed to a second target speed greater than the first target speed, as shown in the period from M to N. In the speed-holding stage (step 506), the stepping motor 300 is continuously driven at the second target speed, as shown in the period after N in FIG. 6. As mentioned above, the step number in the motor-starting stage, the speed-changing stage and the speed-holding stage amount to equal to the total step number. Moreover, the stepping motor has to overcome a dynamic friction torque when rotating. Therefore, the second target speed should be less than or equal to a speed Rm that corresponds to the maximum allowable excitation frequency for the stepping motor 300 to overcome the dynamic friction torque. The second target speed is greater than a speed Rs that corresponds to the maximum allowable excitation frequency for the stepping motor 300 to overcome the static friction torque.

Additionally, the method of the present invention uses a circuit (not shown) to control the sled-home operation. In one embodiment, the circuit can be a microprocessor for executing a firmware program code. All target speeds and all parameters required in each stage of the required calculation are programmed in the firmware program code in advance. In another embodiment, the circuit can be a logic circuit to execute the present invention method. Combinations of logic gates and electronic elements implement the above target speeds and all parameters required in each stage of the required calculation.

Those skilled in the art will readily observe that numerous modifications and alterations of the device and method may be made while retaining the teachings of the invention. Accordingly, the above disclosure should be construed as limited only by the metes and bounds of the appended claims.

1. A method for controlling a sled-home operation in an optical disc drive by driving a sled motor, the method comprising:
driving the sled motor at a first target speed; and
driving the sled motor according to a target speed curve;
wherein target speeds of the target speed curve are all less than or equal to a speed Rm that corresponds to a maximum allowable excitation frequency for the sled motor to overcome a dynamic friction torque, and are greater than a speed Rs that corresponds to a maximum allowable excitation frequency for the sled motor to overcome a static friction torque.

2. The method of claim 1, where in the step for driving the sled motor according to the target speed curve further comprising:
changing the target speed of the sled motor from the first target speed to a second target speed greater than the first target speed and less than or equal to the speed Rm, the second target speed being greater than the speed Rs.

3. The method of claim 1 further comprising: after changing the target speed, continuously driving the sled motor at the second target speed.

4. The method of claim 1 wherein the sled motor is a stepping motor.

5. The method of claim 4 further comprising: stopping driving the sled motor when a step number of the sled motor is equal to a total step number.

6. The method of claim 5 wherein the total step number is derived from a required number of steps for the sled to move from an outer location to an inner location.

7. The method of claim 1 wherein the first target speed is less than or equal to the speed Rs.

8. A device for controlling a sled-home operation in an optical disc drive, the device comprising:
a sled;
a sled motor for controlling movement of the sled; and
a circuit that drives the sled motor at a first target speed; and changes the target speed of the sled motor according to a target speed curve;
wherein target speeds of the target speed curve are all less than or equal to a speed Rm that corresponds to a maximum allowable excitation frequency for the sled motor to overcome a dynamic friction torque, and are greater than a speed Rs that corresponds to a maximum allowable excitation frequency for the sled motor to overcome a static friction torque.

9. The device of claim 8 wherein according to the target speed curve, the circuit changes the target speed of the sled motor from the first target speed to a second target speed greater than the first target speed and less than or equal to the speed Rm, the second target speed being greater than the speed Rs.

10. The device of claim 9 wherein the circuit further continuously drives the sled motor at the second target speed, after changing the target speed.

11. The device of claim 9 wherein the sled motor is a stepping motor.

12. The device of claim 11 wherein the sled motor is not driven when a step number of the sled motor is equal to a total step number.

13. The device of claim 12 wherein the total step number is derived from a required number of steps for the sled to move from an outer location to an inner location.

14. The device of claim 9 wherein the first target speed is less than or equal to the speed Rs.

15. The device of claim 9 wherein the circuit is a microprocessor for executing a firmware program code.

16. The device of claim 9 wherein the circuit is a logic circuit.
